(19) United States
(12) Patent Application Publication
(10) Pub. No.: US 2025/0206620 A1
(43) Pub. Date: Jun. 26, 2025

(54) METHOD OF PREPARING ACTIVATED CARBON DERIVED FROM WASTE PET PLASTIC WITH IMPROVED YIELD USING SELF-PRESSURIZED PYROLYSIS AND CARBON DIOXIDE ADSORBENT PREPARED THEREBY

(71) Applicant: KOREA UNIVERSITY RESEARCH AND BUSINESS FOUNDATION, Seoul (KR)

(72) Inventors: Ki Bong LEE, Seoul (KR); Moon Kyung CHO, Seoul (KR); Shuangjun LI, Tianjin (CN)

(73) Assignee: KOREA UNIVERSITY RESEARCH AND BUSINESS FOUNDATION, Seoul (KR)

(21) Appl. No.: 18/737,581

(22) Filed: Jun. 7, 2024

(30) Foreign Application Priority Data
Dec. 20, 2023 (KR) 10-2023-0187683

(51) Int. Cl. C01B 32/324; B01D 53/02; B01J 20/20; B01J 20/28; B01J 20/30; C01B 32/348; C01B 32/354; C10B 53/07

(52) U.S. Cl. CPC C01B 32/324; B01D 53/02; B01J 20/20; B01J 20/28016; B01J 20/28064; B01J 20/28066; B01J 20/28071; B01J 20/28073; B01J 20/3071; B01J 20/3078; B01J 20/3085; C01B 32/348; C01B 32/354; C10B 53/07; B01D 2253/102; B01D 2253/306; B01D 2253/311; B01D 2257/504; C01P 2002/72; C01P 2004/03; C01P 2004/04; C01P 2006/12; C01P 2006/14; C01P 2006/17

(57) ABSTRACT

The present invention discloses a preparation method of activated carbon derived from waste PET plastic with improved yield using self-pressurized pyrolysis and a carbon dioxide adsorbent prepared thereby. According to the present invention, a preparation method of activated carbon comprising the steps of cutting waste PET plastic into pieces of a predetermined size or smaller; charging the cut pieces into an autoclave reactor; carbonizing the pieces through a self-pressurized pyrolysis reaction by heating the autoclave reactor to a preset carbonization temperature under a nitrogen atmosphere; dry mixing the pyrolytic carbon solid obtained by carbonization with KOH; and subjecting the mixture to a thermochemical reaction at a preset activation temperature for a preset time is provided.

### CROSS-REFERENCE TO RELATED APPLICATION

This application claims under 35 U.S.C. § 119 (a) the benefit of Korean Patent Application No. 10-2023-0187683 filed on Dec. 20, 2023, the entire contents of which are incorporated herein by reference.

### BACKGROUND

### (a) Technical Field

The present invention relates to a method for preparing activated carbon derived from waste polyethylene terephthalate (PET) plastic with improved yield using self-pressurized pyrolysis, and a carbon dioxide adsorbent prepared thereby, and more specifically, to a method of increasing the yield of waste PET-based activated carbon with excellent carbon dioxide adsorption performance using a self-pressurized pyrolysis method and an activation method through thermochemical reaction.

### (b) Background Art

Since carbon dioxide is a representative greenhouse gas that affects global warming, technology development to reduce carbon dioxide emissions into the atmosphere is actively underway.

There are various separation technologies to remove carbon dioxide from flue gas, which contains a large amount of carbon dioxide emitted from industrial facilities such as steel, petrochemical, and coal-fired power plants. Among these, the adsorption method can be applied as an alternative technology that complements the disadvantages of the existing absorption method, such as the problems of equipment corrosion and the high energy consumption required for the regeneration of the absorbent solution.

Among carbon dioxide adsorption materials, activated carbon has the advantage of low preparation cost and excellent repetitive adsorption uptake. In addition, if waste PET plastic is used as a precursor for activated carbon, it can simultaneously solve the problem of global warming caused by greenhouse gases and the issues of environmental pollution caused by waste plastic.

Most of the conventional technologies for converting waste PET plastic into activated carbon generate a large amount of by-products mainly consisting of terephthalic acid generated during the carbonization process, which cause a decrease in the yield of activated carbon and secondary environmental pollution.

### PRIOR ART DOCUMENT

### [Patent Document]

KR Patent No. 10-2197821

### SUMMARY OF THE DISCLOSURE

In order to solve the problems of the prior art described above, the present invention seeks to propose a method for preparing activated carbon derived from waste PET plastic with improved yield, which prevents the problem of emission of by-products using self-pressurized pyrolysis, and a high-performance carbon dioxide adsorbent prepared thereby.

In order to achieve the object as described above, according to one embodiment of the present invention, provided is a method for preparing activated carbon comprising the steps of: grinding waste PET plastic into pieces of a predetermined size or smaller; charging the ground pieces into an autoclave reactor; carbonizing the pieces through a self-pressurized pyrolysis reaction by heating the autoclave reactor to a preset carbonization temperature under a nitrogen atmosphere; dry mixing the pyrolytic carbon solid obtained by carbonization with KOH; and subjecting the mixture to a thermochemical reaction at a preset activation temperature for a preset time.

The carbonizing step may include a step of heating the autoclave reactor to the carbonization temperature at a preset heating rate; and a step of maintaining the carbonization temperature for 30 minutes.

The activation temperature can range from 600 to 900° C. for the development of micropores of 1 nm or less.

The dry mixing step may include a step of mixing the pyrolytic carbon solid and KOH in the form of powder so that the mass ratio is 1:2.

After the step of treating with the thermochemical reaction, a step of washing the activated material obtained through the treatment by the thermochemical reaction using an HCl solution and distilled water; and a step of drying at a predetermined temperature to obtain activated carbon in the final form of powder may be further included.

According to another aspect of the present invention, activated carbon prepared through the above method is provided.

In addition, according to yet another aspect of the present invention, a carbon dioxide adsorbent containing activated carbon prepared through the above method is provided.

According to the present invention, the self-pressurized pyrolysis method can not only increase the yield of solid carbon materials produced from waste PET plastic, but also prevent environmental pollution by reducing the amount of by-products generated.

In addition, according to the present invention, since a dry mixing method is used to mix pyrolytic carbon solid and an activator, activated carbon can be prepared in an environmentally friendly manner compared to the conventional solution mixing method.

Furthermore, according to the present invention, by using waste PET plastic as a raw material for activated carbon for the adsorption of carbon dioxide, the cost of processing waste plastic is reduced, and the problems of environmental pollution caused by waste plastic and global warming can be solved at the same time, and a method of increasing yield can be proposed in the preparation of carbon materials that use polymers as well as waste PET plastic as raw materials.

### BRIEF DESCRIPTION OF THE DRAWINGS

FIG. 1 is a diagram showing a flow chart of the preparation process of activated carbon according to a preferred embodiment of the present invention.

FIG. 2 schematically shows a method for preparing waste PET plastic-based activated carbon according to an embodiment of the present invention.

FIG. 3 compares the change (solid line) in mass of pyrolytic carbon solid when waste PET plastic was thermally decomposed at heating rates of 2.5, 5, and 10° C./min in an atmosphere of nitrogen flow, with the change (dots) in mass of pyrolytic carbon solid when using the self-pressurized pyrolysis method.

FIG. 4 shows nitrogen adsorption and desorption isotherms at −196° C. for CPET6-Kx-DM and CPET6-Kx-SM samples.

FIG. 5 shows the pore size distribution of CPET6-Kx-DM and CPET6-Kx-SM samples. The solid and dashed lines represent the differential pore volume and cumulative pore volume, respectively.

FIG. 6 is the result of XRD spectrum analysis of CPET6-Kx-DM sample.

FIG. 7 shows a SEM image of CPET6-K8-DM sample.

FIG. 8 shows a HR-TEM image of CPET6-K8-DM sample.

FIG. 9 shows adsorption isotherms of CPET6-Kx-DM and CPET6-Kx-SM samples for carbon dioxide and nitrogen at 25° C.

FIG. 10 shows the results of carbon dioxide adsorption and desorption tests using the CPET6-K8-DM sample at gas flow conditions of 30, 50, and 70° C.

### DETAILED DESCRIPTION

Since the present invention can apply various modifications and have various embodiments, specific embodiments will be illustrated in the drawings and described in detail in the detailed description. However, these are not intended to limit the present invention to specific embodiments, and should be understood to include all changes, equivalents, and substitutes included in the spirit and technical scope of the present invention.

The terms used herein are used only to describe specific embodiments and are not intended to limit the invention. Singular expressions include plural expressions unless the context clearly dictates otherwise. It is to be understood that the terms such as “comprise” or “have” as used in the present specification, are intended to designate the presence of stated features, numbers, steps, operations, components, parts or combinations thereof, but not to preclude the possibility of the presence or addition of one or more other features, numbers, steps, operations, components, parts, or combinations thereof.

In addition, it is natural that components of the embodiment described with reference to each drawing are not limited only to the corresponding embodiment and may be implemented to be included in other embodiments within the scope of maintaining the technical spirit of the present invention, and also even if separate description is omitted, multiple embodiments may be re-implemented as one integrated embodiment.

In addition, in describing with reference to the accompanying drawings, regardless of the reference numerals, identical components will be given the same or related reference numerals, and duplicate descriptions thereof will be omitted. Also, in describing the present invention, if it is determined that a detailed description of related known technologies may unnecessarily obscure the gist of the present invention, the detailed description will be omitted.

FIG. 1 is a diagram showing a flow chart of the preparation process of activated carbon according to a preferred embodiment of the present invention.

In this embodiment, activated carbon is prepared by subjecting waste PET plastic to self-pressurized pyrolysis and thermochemical reaction.

Referring to FIG. 1, waste PET plastic is first washed and dried, and cut into pieces of a predetermined size (e.g., less than 3 mm) (Step 100).

Next, pieces of the cut waste PET plastic are put into an autoclave reactor in a nitrogen gas atmosphere (step 102), and heated at a preset heating rate to a preset temperature and carbonized through self-pressurized pyrolysis for a predetermined time (Step 104).

Pyrolytic carbon solid is obtained through the carbonization process described above (Step 106).

According to this embodiment, KOH in the form of powder is mixed in a dry manner with pyrolytic carbon solid and put into a horizontal tubular furnace (Step 108), and heated at a preset heating rate to a preset temperature and activated through treatment by thermochemical reaction for a preset time (Step 110).

The activated material is washed with HCl solution and distilled water and then dried to produce activated carbon in the form of final powder (Step 112).

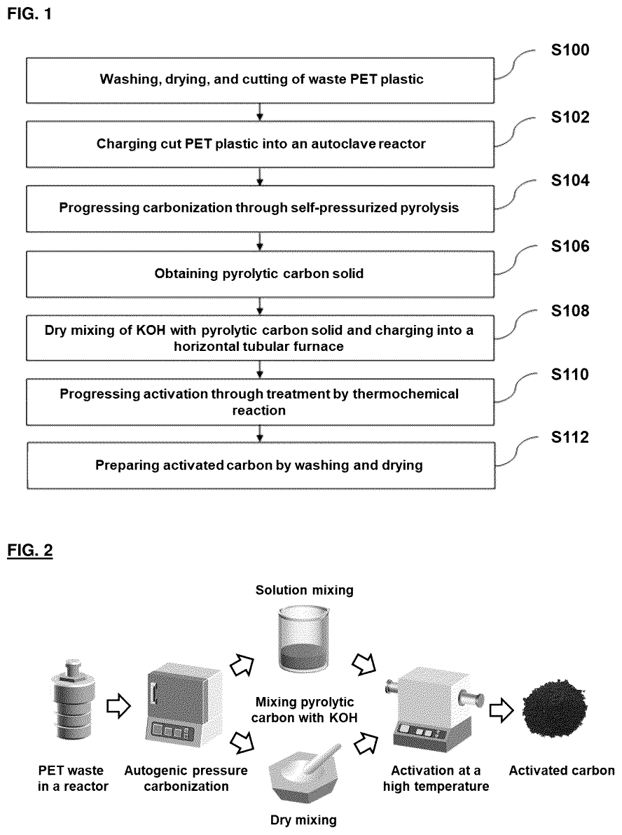

FIG. 2 schematically shows the preparation method of waste PET plastic-based activated carbon according to this embodiment, and FIG. 2 is a diagram showing an experiment for comparing performances between the case of dry mixing of pyrolytic carbon solid and KOH and the case of solution mixing of them.

In this experiment, 2.4 g of waste PET plastic was put into an autoclave reactor with a volume capacity of 72 mL in a nitrogen gas atmosphere.

It was heated until it reached 300 to 700° C. at different heating rates of 2.5, 5, and 10° C./min, and then maintained at each temperature for 30 minutes to proceed with carbonization through the self-pressurized pyrolysis method.

In addition, according to this embodiment, in order to compare performances between the case of dry mixing of pyrolytic carbon solid and KOH and the case of solution mixing of them, KOH in the form of powder is mixed with the pyrolytic carbon solid in a dry or wet manner so that the mass ratio is 2 and put into a horizontal tubular furnace, heated at a heating rate of 10° C./min until it reaches 600 to 900° C., and then held at each temperature for 1 hour to activate through treatment by thermochemical reaction. The activated material was washed with HCl solution and distilled water, then dried in an oven at 110° C. to prepare activated carbon in the form of final powder.

Hereinafter, the finally prepared activated carbon is indicated as CPET6-Kx-DM or CPET6-Kx-SM (wherein 6 represents 600° C. which is the temperature of self-pressurized pyrolysis, x represents the processing temperature of thermochemical reaction/100° C., DM (Dry Mixing) represents the dry mixing method, and SM (Solution Mixing) represents the solution mixing method).

Below, the characteristics and carbon dioxide adsorption performance of activated carbon prepared through the experiment as shown in FIG. 2 will be described in detail.

### Analysis of Characteristics of Waste PET Plastic-Based Activated Carbon

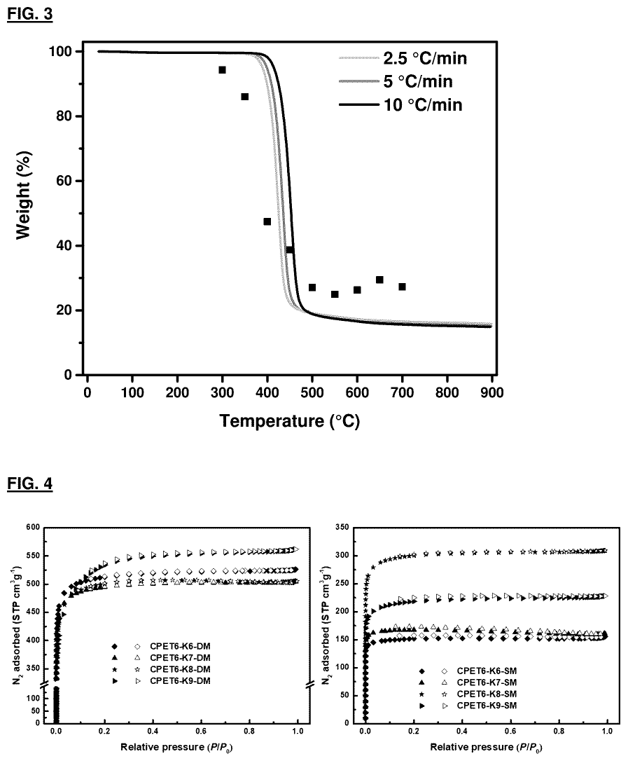

FIG. 3 compares the change (solid line) in mass of pyrolytic carbon solid when waste PET plastic was thermally decomposed at heating rates of 2.5, 5, and 10° C./min in an atmosphere of nitrogen flow (flow-type reactor), with the change (dots) in mass of pyrolytic carbon solid when using the self-pressurized pyrolysis method (autoclave reactor).

As shown in FIG. 3, it can be seen that compared to the pyrolysis method carried out in an atmospheric nitrogen gas flow in a flow-type reactor, the yield of pyrolytic carbon solid increases at temperatures of 500° C. or more in the case of the self-pressurized pyrolysis method through an autoclave reactor, and it can be seen that self-pressurized pyrolysis is performed at around 600° C., the stable yield of pyrolytic carbon solid is improved by more than 7% compared to the conventional carbonization method.

As in this embodiment, if carbonization is performed using an autoclave reactor rather than a flow-type reactor, the pressure increases during carbonization inside the reactor, thereby increasing the yield of pyrolytic carbon solid.

FIG. 4 shows nitrogen adsorption and desorption isotherms at −196° C. for CPET6-Kx-DM and CPET6-Kx-SM samples.

As shown in FIG. 4, it can be seen that the low-temperature nitrogen adsorption and desorption isotherm of the prepared activated carbon is of type I according to the classification of the International Union of Pure and Applied Chemistry (IUPAC), and activated carbon prepared by a dry mixing method or a solution mixing method is a porous carbon material with micropores.

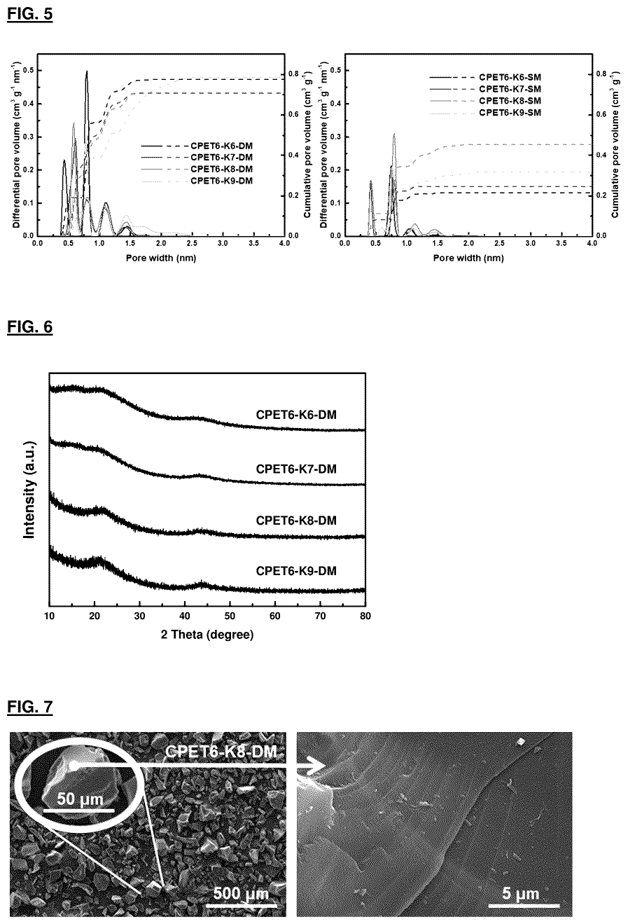

FIG. 5 shows the pore size distribution of CPET6-Kx-DM and CPET6-Kx-SM samples. The solid and dashed lines represent the differential pore volume and cumulative pore volume, respectively.

FIG. 5 is a pore size distribution chart calculated based on non-local density functional theory (NLDFT) by assuming a slit pore model and using data from low-temperature nitrogen adsorption and desorption isotherms of activated carbon.

It can be seen that all of the prepared activated carbons had well-developed micropores, and in particular, micropores with a size of 1 nm or less were greatly developed. Based on this, it can be expected that the prepared activated carbon has an advantageous effect on the adsorption of carbon dioxide gas.

In addition, it can be seen that in activated carbon prepared by the dry mixing method as in this embodiment, more micropores are developed compared to activated carbon prepared by the solution mixing method.

FIG. 6 shows the results of X-ray diffraction (XRD) spectrum analysis of the CPET6-Kx-DM sample.

As shown in FIG. 6, it can be seen that as a result of XRD analysis, CPET6-Kx-DM shows broadly distributed peaks around 2 theta at 20° and 45° and has the form of a typical amorphous porous carbon structure.

FIG. 7 shows a scanning electron microscope (SEM) image of the CPET6-K8-DM sample.

Through the SEM image in FIG. 7, it can be seen that most of the activated carbon of CPET6-K8-DM has a size of about 50 μm.

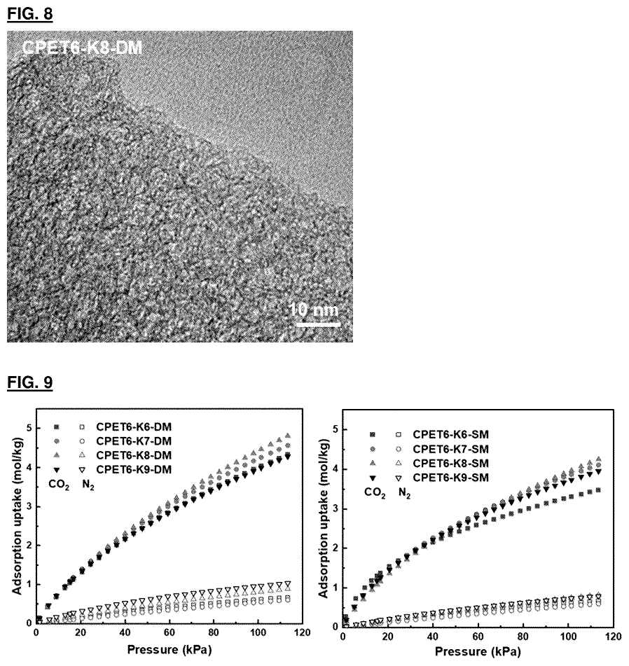

FIG. 8 shows a high-resolution transmission electron microscope (HR-TEM) image of the CPET6-K8-DM sample.

As shown in the TEM image of FIG. 8, it can be confirmed that CPET6-K8-DM has a surface with highly developed pores, and based on this, it can be expected that the access and adsorption of carbon dioxide into micropores will be advantageous.

Table 1 shows the textural properties calculated based on the low-temperature nitrogen adsorption and desorption isotherm of the prepared activated carbon. In the textural properties of Table 1, S_{BET} is the specific surface area calculated by the BET method (Brunauer-Emmett-Teller method), Vₜₒₜₐₗ is the total pore volume at P/P0˜0.99, and V_{micro} is the volume of micropores calculated based on the Dubinin-Radushkevich equation. It can be seen that activated carbon prepared by the dry mixing method has a larger specific surface area than activated carbon prepared by the solution mixing method, and has a high degree of development of overall pores and micropores.

TABLE 1

| Sample | S_{BET} (m²/g) | Vₜₒₜₐₗ (cm³/g) | V_{micro} (cm³/g) |
|---|---|---|---|
| CPET6-K6-DM | 1991 | 0.814 | 0.791 |
| CPET6-K7-DM | 1923 | 0.781 | 0.770 |
| CPET6-K8-DM | 1931 | 0.781 | 0.768 |
| CPET6-K9-DM | 1970 | 0.869 | 0.752 |
| CPET6-K6-SM | 592 | 0.242 | 0.230 |
| CPET6-K7-SM | 660 | 0.271 | 0.260 |
| CPET6-K8-SM | 1160 | 0.479 | 0.463 |
| CPET6-K9-SM | 838 | 0.353 | 0.331 |

### Carbon Dioxide Adsorption Performance of Waste PET Plastic-Based Activated Carbon

FIG. 9 shows the adsorption isotherms of CPET6-Kx-DM and CPET6-Kx-SM samples for carbon dioxide and nitrogen at 25° C.

As shown in FIG. 9, it can be confirmed that activated carbon prepared by the dry mixing method shows a higher amount of carbon dioxide adsorption compared to activated carbon prepared by the solution mixing method. As the activation temperature through treatment by thermochemical reaction is increased, the carbon dioxide adsorption amount is increased at 25° C. and 1 atm, and the highest adsorption amount was shown in activated carbon activated at 800° C., and then decreased. In addition, it can be confirmed that the prepared activated carbon shows a high carbon dioxide adsorption amount compared to nitrogen, and thus it can be used as a carbon dioxide selective adsorbent.

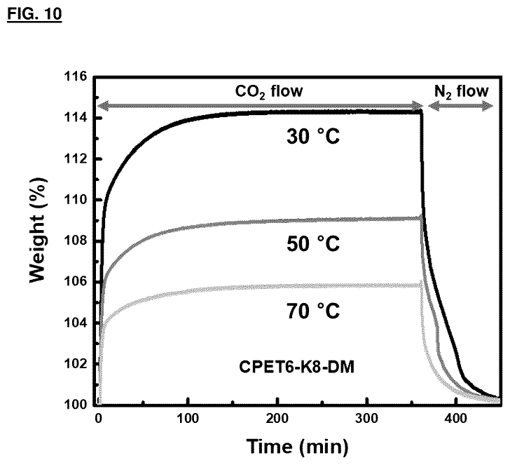

FIG. 10 shows the results of carbon dioxide adsorption and desorption tests using the CPET6-K8-DM sample at gas flow conditions of 30, 50, and 70° C.

As shown in FIG. 10, it can be seen that the initial adsorption rate of CPET6-K8-DM is high in a carbon dioxide flow atmosphere, and it can be confirmed that efficient desorption is achieved simply by switching to a nitrogen flow atmosphere after adsorption saturation. Based on this, it can be expected that the prepared activated carbon can be applied to industry as an effective carbon dioxide absorbent.

Table 2 summarizes the carbon dioxide and nitrogen adsorption amounts and carbon dioxide selectivity to nitrogen of CPET6-Kx-DM at 25° C. and 1 atm. At this time, the selectivity was calculated at simulated flue gas concentrations (carbon dioxide volume:nitrogen volume=15:85) by applying ideal adsorbed solution theory (IAST) to the single adsorption isotherm of carbon dioxide and nitrogen.

$${S}_{{CO}_{2} / {N}_{2}} = \frac{{q}_{{CO}_{2}} / {P}_{{CO}_{2}}}{{q}_{{N}_{2}} / {P}_{{N}_{2}}} \qquad [ Equation 1 ]$$

wherein, S_{CO2/N2} is the selectivity of carbon dioxide to nitrogen, q_{CO2} is the amount of carbon dioxide adsorption, q_{N2} is the amount of nitrogen adsorption, P_{CO2} is the partial pressure of carbon dioxide, and P_{N2} is the partial pressure of nitrogen.

TABLE 2

| | Adsorbed CO₂ | Adsorbed N₂ | IAST |
|---|---|---|---|
| Sample | amount (mmol/g) | amount (mmol/g) | selectivity |
| CPET6-K6-DM | 4.01 | 0.62 | 10.06 |
| CPET6-K7-DM | 4.23 | 0.55 | 12.14 |
| CPET6-K8-DM | 4.44 | 0.81 | 7.99 |
| CPET6-K9-DM | 3.96 | 0.97 | 6.34 |

The above-described embodiments of the present invention have been disclosed for illustrative purposes, and those skilled in the art will be able to make various modifications, changes, and additions within the spirit and scope of the present invention, and it should be considered that such modifications, changes and additions fall within the scope of the claims below.

What is claimed is:

1. A preparation method of activated carbon comprising, the steps of:
cutting waste PET plastic into pieces of a predetermined size or smaller;
charging the cut pieces into an autoclave reactor;
carbonizing the pieces through a self-pressurized pyrolysis reaction by heating the autoclave reactor to a preset carbonization temperature under a nitrogen atmosphere;
dry mixing the pyrolytic carbon solid obtained by carbonization with KOH; and
subjecting the mixture to a thermochemical reaction at a preset activation temperature for a preset time.

2. The preparation method according to claim 1, wherein the carbonizing step comprises a step of heating the autoclave reactor to the carbonization temperature at a preset heating rate; and a step of maintaining the carbonization temperature for 30 minutes.

3. The preparation method according to claim 1, wherein the activation temperature ranges from 600 to 900° C. for the development of micropores of 1 nm or less.

4. The preparation method according to claim 1, wherein the dry mixing step comprises mixing the pyrolytic carbon solid and KOH in the form of powder so that the mass ratio is 1:2.

5. The preparation method according to claim 1, further comprising after the step of treating with the thermochemical reaction, a step of washing the activated material obtained through the treatment by the thermochemical reaction using an HCl solution and distilled water; and a step of drying at a predetermined temperature to obtain activated carbon in the final form of powder.

6. An activated carbon prepared through the preparation method according to claim 1.

7. A carbon dioxide adsorbent, comprising the activated carbon prepared through the preparation method according to claim 1.
